(19) United States
(12) Patent Application Publication
(10) Pub. No.: US 2001/0016056 A1
(43) Pub. Date: Aug. 23, 2001

(54) Hand-held computer

(75) Inventors: Martin Westphal, Karlsruhe (DE); Martin Schinkmann, Karlsruhe (DE)

Correspondence Address: COLLARD & ROE, P.C., 1077 Northern Boulevard, Roslyn, NY, 11576-1696, US

(73) Assignee: Medical Communications Soft-und Hardware GmbH

(21) Appl. No.: 09/790,950

(22) Filed: Feb. 22, 2001

(30) Foreign Application Priority Data
Feb. 23, 2000 (DE) 200 03 469.3

(51) Int. Cl. G06K 9/00

(52) U.S. Cl. 382/128; 128/903

(57) ABSTRACT

A hand-held computer for the display and processing of medical data having a portable housing (2), a processor with both a working memory and a hard disk memory, a touch screen connected to the processor (3), a rechargeable battery, and corresponding I/O interfaces (10-17). The processor is programmed with a medical image processing and diagnosis software for receiving medical image data in the DICOM standard, wherein the maximum displayable number of differentiated individual image displays is limited in number, corresponding to the size of the touch screen (3). A passive pen (4) is provided to operate the touch screen (3) as an additional input device. An infrared interface is provided for feeding in medical data from a mainframe computer and/or a computer network. The processor also has a data connection with a radio reception and transmission device for wireless data exchange via a mobile radio network, and includes a modem, integrated in the processor. The operating system also has access software with at least one integrated Web browser.

### BACKGROUND OF THE INVENTION

1. Field of the Invention

This invention relates to a hand-held computer to display and process medical data, with a portable housing, a processor with a working memory and a hard disk memory, as well as a touch screen, a rechargeable battery, and corresponding I/O interfaces.

2. Prior Art

In recent years, electronic data processing has resulted in significant progress on the one hand, and in a significant increase in the medical data to be processed during the course of a treatment, on the other hand, in the field of medical technology, as in many other fields. In most hospitals, all the biographical data for patients are first collected and stored in memory, so that in the final analysis, an electronic patient file is available. Furthermore, during a normal hospital stay, a number of additional electronic data are collected in connection with the diagnosis and treatment of the subject patient. For example, in connection with imaging procedures of X-ray diagnosis or computer tomography, electronic image data are collected, which are recorded using imaging equipment. This data is frequently processed, diagnosed, or at least archived using other electronic diagnosis systems. Ideally, these data also get into the electronic patient file in electronic form.

At the same time as medical equipment has progressed, patients increasingly feel the need to be able to participate in a diagnosis, i.e. at least to have the diagnosis explained to them. Therefore, X-rays or CAT scans are usually discussed with the patient, using visual devices. Such visual devices are also frequently used for team diagnostics.

A majority of the patients, however, are confined to bed and therefore hardly able to follow any explanation using a visual device. These visual devices are usually not mobile, so that in this case, the doctor has to do without the illustrations for an explanation. Furthermore, the patient often has questions only afterwards, questions that he or she would like to discuss with the doctor on the basis of the image data. The rounds of visits made for these discussions, usually on a daily or at least a regular basis, are no help in this case, since the data in question are not available, or only insufficiently available, during such a visit. It is often a disadvantage for the doctor that a review and diagnosis of electronic image data is only possible, apart from the patient.

### SUMMARY OF THE INVENTION

The invention therefore provides a device for processing medical data in mobile form, and to diagnose and discuss this data with the patient, if necessary.

This task is accomplished, using a hand-held computer for the display and processing of medical data. Here, medical image processing and diagnostic software is provided for medical image data, particularly in the DICOM standard, and implemented on this hand-held computer, where the maximum displayable number of differentiated individual image displays, in each case, is preferably limited to a number corresponding to the size of the touch screen.

This hand-held computer makes it possible to carry along the electronic patient file, as well as a number of additional medical data of interest, such as image data, in a mobile manner, while making rounds or otherwise. The I/O interfaces permit a flexible data exchange with existing computer systems or computer networks. As compared with previously known solutions, which use a laptop, a significant advantage in operating the hand-held computer according to the invention lies in the smaller dimensions of the device, which make it possible to work with the device without having a special place to put it down. Usually, no such areas are available during a visit to a patient, or while making rounds, at least not by the patient's bed.

The usefulness of such a hand-held computer over a conventional laptop, is that it does not have a keyboard that requires a lot of space, and instead, provides a touch screen with a passive pen for operation. In this connection, the passive pen essentially fulfills the so-called “mouse function.” All of the systems used on the hand-held computer are therefore structured so that the usual keyboard entries are not required.

It is advantageous if the hand-held computer of the invention is provided with an infrared interface for wireless data exchange. The hand-held computer can communicate with existing systems using this infrared interface. A printer, for example, can be addressed via the corresponding infrared interfaces.

In another development, the hand-held computer is provided with a radio reception and transmission device for wireless data exchange, particularly via a mobile radio network. In this way, data that are located remotely can also be entered into the computer, and wireless coupling to an Internet or Intranet can also take place. As an alternative, or in addition, an integrated modem for data exchange can be provided.

In another development, the hand-held computer according to the invention is provided with a GPS system, which permits precise positioning of the hand-held computer being used for each case.

By using a GPS system, electronic data can be transmitted to the computer, for example, as a function of the position of the hand-held computer. This means that during rounds in different departments, the data for the department in question can be transmitted automatically, by wireless transmission. In this connection, the GPS system can be used in combination with additional internal navigation systems, or function automatically.

The hand-held computer is provided with access software with an integrated browser. In this way, the hand-held computer can enter into a data exchange with the World Wide Web (WWW).

In an advantageous development, at least one integrated browser with a fixed bookmark implemented for a medical Internet portal designed specifically for the needs of the hand-held computer is provided. In this way, the hand-held computer can call up and trigger diagnostic and analysis systems that can usually not be carried out on the basis of the on-board processor performance, and the memory capacity of a hand-held computer. However, the hand-held computer can pass medical data on to diagnosis and analysis systems that run on a mainframe computer that is also coupled into the World Wide Web via a corresponding Internet interface. In this way, analysis and diagnosis systems can be used and called up by the user using the hand-held computer, without additional equipment technology or electronic effort on the user's part, which would otherwise be available only in combination with mainframe computer systems such as those in high-technology clinics and hospitals.

A medical image processing and diagnosis software that is suitable for processing and display of medical image data in the DICOM standard is implemented on the hand-held computer. The DICOM standard has proven to be an open and, in particular, manufacturer-independent communications platform for medical images and image-related information, and guarantees interoperability between the most varied types of devices. The DICOM data structure not only includes medical image data, but fundamentally comprises a header that contains the modality of the imaging record in question, the equipment parameters, and the like. The DICOM standard allows the hand-held computer according to the invention, to enter into data exchange with the most varied systems of medical image generation and image processing.

If entire image series, such as those that are usual in connection with CAT scans, have been created, the image processing and diagnosis software is adapted to the hand-held computer so that the number of distinguishable individual images that can be displayed in each case is suitable for the size of the touch screen.

A single control panel is assigned to all of the individual image displays; and this panel can be operated by means of the passive pen.

Using the passive pen, a zoom function, preferably in the form of a magnifying lens function, can also be used via the operating panel or in another way, for an enlarged view of individual images or image details that have been selected. Individual operation of the contrast image can also take place, in each case.

The image data in the memory of the hand-held computer, in the DICOM standard, can be processed further by means of the usual image processing programs, and word processing programs, to convert them to formats such as TIFF and JPEG. All of the image data or individual images that are displayed can be stored in temporary memory, and are therefore accessible to further processing.

The interoperability of the hand-held computer according to the invention is increased in that an e-mail tool is assigned to the image processing and diagnosis software. This tool supports an SMTP server, a POP3 server, and/or an IMAP4 server for sending and receiving e-mails, and furthermore makes it possible to code and decode medical image data for sending or receiving them as an e-mail.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a hand-held computer in a top view; and

FIG. 2 shows the hand-held computer of FIG. 1 in a back view.

### DETAILED DESCRIPTION OF THE PREFERRED EMBODIMENT

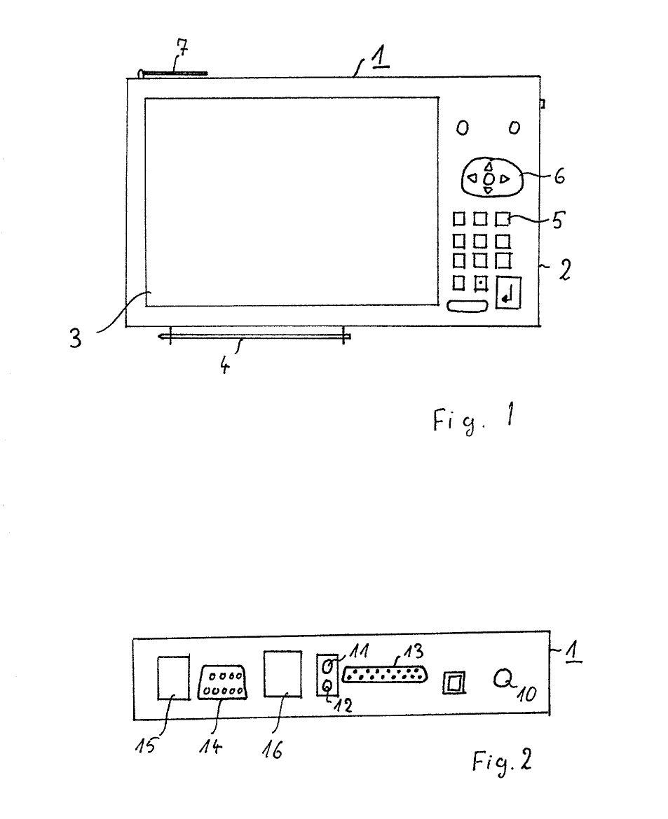

Referring now in detail to the drawings, FIG. 1 shows a hand-held computer 1 containing a portable housing 2, the front view of which is essentially determined by a relatively large touch screen 3. At the same time, touch screen 3 represents a display element for medical data as well as an input element, which can be operated in connection with a corresponding passive pen 4, which is releasably connected with housing 2. Operation via the passive pen 4 can take place in wireless or wired manner. Instead of a passive pen 4, the touch screen can also be operated with the bare hand, via so-called soft keys. Instead of the touch screen, a conventional display can also be used, in combination with a light pen or a mouse.

The front panel of housing 2 also has a predominantly numeric keyboard 5 that can also be used to input other characters, using a corresponding dual assignment. Furthermore, a multi-function key 6 for cursor control is assigned to the control panel of housing 2. Multi-function key 6 makes it possible to operate the hand-held computer 1 even without passive pen 4. Furthermore, a GPS antenna 7 is arranged on the outside of housing 2. In addition to the visible GPS antenna, hand-held computer 1 has a mobile radio antenna and, if necessary, also a radio antenna (not shown). The receiver units related with the antennas in question are uncoupled by means of corresponding shielding devices, to ensure reception without interference, in each case.

Hand-held computer 1 shown in FIG. 1 is preferably provided with a 266 MHz Celeron® processor, a 4.3 GByte hard disk, as well as 160 MByte RAM. The unusually large working memory allows easy processing and display even of large amounts of data, such as the amounts in connection with image data. Hand-held computer 1 furthermore has a lithium ion rechargeable battery as an energy supply, independent of the electrical network. Touch screen display 3 is preferably an 8.4″ SVGA display.

The easy-to-use design of the equipment also becomes clear from the interfaces on the back of the device as shown in FIG. 2. An external power source can be connected via an appropriate 12 volt power supply, via an AC input 10. The device can also be connected to the power net of a motor vehicle, using a corresponding adapter.

A microphone, for example, can be connected to the handheld computer 1 via the audio input 11, for speech input. Stereo headphones, for example, can be connected via an audio output 12. An external printer can be connected with hand-held computer 1 via a parallel port 13. External modems or other computer peripherals, for example, can be connected with hand-held computer 1 via serial port 14. An RJ 45 interface with a corresponding network card allows hand-held computer 1 to be wired into a conventional Intranet. In addition, an infrared interface 16, preferably an IRDA 1.1 interface, is provided for the wireless exchange of data. An integrated, preferably 56K modem, can be connected with a telephone network via the RJ 11 output.

The device has a series of other inputs and outputs, not shown, for example for connecting passive pen 4 or a docking station. In addition, a DC input can also be provided. A serial port 14 supports RS 232 signals for bidirectional communication between peripherals and hand-held computer 1.

GPS antenna 7 is in data connection with a corresponding reception unit inside the device.

Housing 2 is furthermore provided with a docking station, not shown in greater detail, for a direct connection to a computer. Housing 2 is furthermore provided with a removable carrying handle.

In the following, the function of hand-held computer 1 according to the invention, for display and processing of medical data, will be explained in greater detail.

The hand-held computer according to the invention is usually carried along by the user in each instance, generally the treating physician. A medical image processing and diagnosis software is installed on hand-held computer 1, which software can process and display the image data that are available in the DICOM standard. The corresponding software, in the present embodiment, runs on the Windows 98® operating system, the Windows NT 4.0 operating system, and the Windows 2000® operating system.

Operation of the software essentially takes place via passive pen 4. The image data available in a hard disk memory, in each instance, are transmitted to computer 1 either via an infrared interface 16, or via a RJ 46 interface 15, by wireless transmission or by wire. Alternatively, the data can also be transmitted via a mobile radio reception device. In connection with the GPS device of hand-held computer 1, the data, in each instance, can also be transmitted as a function of the position of the user, in each case.

The image processing and diagnosis software implemented on hand-held computer 1 is optimally adapted to the 8.4″ display of touch screen 3 which is present here. For example, the number of the individual images of a CAT scan shooting that can be displayed at the same time is limited to four images. CAT scans can be shown and explained to the patient, in each instance, when the user, is making rounds, for example. For this purpose, it is advantageous if a common control panel assigned to the individual images, in each case, has additional features such as a zoom or magnifying lens function as well as a contrast display. The slice planes in the patient body on which the CAT scan or X-ray is based can be shown on an additional individual image, such as a Scout or a Scanogram. The control panel shown on operating touch screen 3 is operated using passive pen 4. Individual images to be enlarged can also be selected using passive pen 4.

The functionality of hand-held computer 1 is significantly improved in that the image processing and diagnosis software has a browser integrated into it, which is provided with a bookmark for a medical Internet portal that supplements the image processing and diagnosis software with functions that require a lot of memory and computer performance. In addition to access to the World Wide Web, this interface can also be used to access other information systems such as a radiology information system (RIS) or a Hospital Information System (HIS). The hand-held computer according to the invention can therefore be used not only in its function as a “display device” but also as an extremely high-quality diagnosis and communications device.

Therefore a mobile data processing device has been described above, that enables the treating physician to carry out a diagnosis and analysis at any time and anywhere, particularly in the presence of the patient, and to make this transparent for the patient. The treating physician can enter into exchange with his/her clinic or practice, via corresponding interfaces with the Internet, and therefore bring along only the amount of data that is necessary in each case. Furthermore, the hand-held computer according to the invention must be understood, in combination with a corresponding Internet link, as a communications interface for an exchange between the treating physician and other doctors or diagnosis systems.

Accordingly, while only several embodiments of the present invention have been shown and described, it is obvious that many changes and modifications may be made thereunto without departing from the spirit and scope of the invention.

What is claimed is:

1. A hand-held computer for the display and processing of medical data with a portable housing (2), a processor with a working memory and a hard disk memory, a touch screen (3) connected to the processor, a rechargeable battery, and corresponding I/O interfaces (10-17) coupled to the processor and comprising:
a medical imaging processing and diagnosis software for receiving medical image data, having the DICOM standard and implemented into the memory of the hand-held computer, wherein the maximum displayable number of differentiated individual image displays is in number limited corresponding to the size of the touch screen (3).

2. The hand-held computer according to claim 1, comprising a passive pen (4) assigned to operate the touch screen (3) as an additional input device.

3. The hand-held computer according to claim 1 wherein said corresponding interfaces comprises an infrared interface for feeding in medical data from a mainframe computer and/or a computer network.

4. The hand-held computer according to claim 3 wherein the processor has a data connection with a radio reception and transmission device for wireless data exchange via a mobile radio network, and includes a modem, integrated in the processor.

5. The hand-held computer according to claim 3 wherein the software of the hand-held computer (1) is equipped with an operating system that has an access software with at least one integrated Web browser.

6. The hand-held computer according to claim 5, wherein at least one Web browser is provided with a bookmark, implemented in fixed manner and provided with a preselectable URL address of a medical Internet portal for the exchange and/or processing of medical data.

7. The hand-held computer according to claim 2 comprising a common control panel assigned to the individual image displays on the touch screen (3), which can be operated by means of said passive pen (4).

8. The hand-held computer according to claim 7, wherein said medical image processing and diagnosis software is provided with a zoom function with a magnifying lens function for providing an enlarged view of details and/or individual images, which is operated via said passive pen (4) and wherein said control panel provides an infinite contrast adjustment of the individual image displays by means of said passive pen (4).

9. The hand-held computer according to claim 7 wherein said image data stored in the hard disk memory in the DICOM standard can be converted into the TIFF and JPEG formats, and temporarily stored in temporary memory.

10. The hand-held computer according to claim 9, wherein said image processing and diagnosis software has an e-mail tool for supporting an SMTP server and a POP3 server or an IMAP4 server, for sending and receiving e-mails, and provides a coding and decoding for medical image data forsending or receiving said data as an e-mail.

11. The hand-held computer according to claim 1 further comprising a Global Positioning System (GPS) integrated with the processor.
